(19) United States
(12) Patent Application Publication
(10) Pub. No.: US 2017/0004283 A1
(43) Pub. Date: Jan. 5, 2017

(54) Methods and Systems for Medication Compliance Monitoring and Notification

(71) Applicant: Casey Lewis, Fayetteville, NY (US)

(72) Inventor: Casey Lewis, Fayetteville, NY (US)

(21) Appl. No.: 15/200,111

(22) Filed: Jul. 1, 2016

Related U.S. Application Data
(60) Provisional application No. 62/187,343, filed on Jul. 1, 2015.

(51) Int. Cl. G06F 19/00

(52) U.S. Cl. CPC G06F 19/3456; G06F 19/322

(57) ABSTRACT

Systems and methods for facilitating adherence with a prescribed medication. A method for notifying a user about a prescribed medication and recording adherence with that prescribed medication includes the steps of: (i) installing a mobile application on a computing device; (ii) setting one or more medication reminders; (iii) receiving, by a user via the mobile application, a medication reminder; (iv) receiving a request for input regarding whether the medication was taken; (v) providing input regarding whether the medication was taken; and (vi) receiving a medication routine adherence report which includes information about the user's adherence with the medication routine.

### CROSS REFERENCE TO RELATED APPLICATION

The present application relates and claims priority to U.S. Provisional Application Ser. No. 62/187,343, filed Jul. 1, 2015, the entirety of which is hereby incorporated by reference.

### FIELD OF THE INVENTION

The present disclosure is directed generally to medication compliance monitoring and notification, and particularly to methods and systems for providing notifications to an individual about medication times and methods, and for monitoring the individual's adherence with prescribes medication routines.

### BACKGROUND

Medication adherence, also known as compliance, is a measure of how well an individual follows a prescribed or expected routine for a medication. The prescribed or expected routine can include number of doses, dosage amounts, timing, secondary factors such as whether the medicine should be taken with food or liquid, and other factors. A medication can include prescription compounds, homemade compounds, over-the-counter compounds, and other types of compounds. The medications may be pharmaceuticals or other chemical compounds that are taken or otherwise inserted, injected, or implanted internally or that are applied or used externally, a physical treatment, or a movement therapy routine, among many other types of medications and treatments.

The lack of adherence to medication routines is a serious health crisis throughout the world. In the United States, for example, more than 35 million Americans use three or more medicines daily but only 25% of them fully adhere to their medication routine. As many as 1 in 50 (20%) of all new prescriptions are never even filled in the first place, making adherence impossible. Fully half of all patients do not follow their medication routine properly. For example, recent studies have suggested that as much as 50% of the two billion prescriptions filled each year are not taken or followed properly. And only roughly 33% of patients finish the prescribed course of medication. Unfortunately, adherence is lowest among patients who have chronic illnesses.

This massive failure to adhere to medication routines has devastating effects on health care costs and effectiveness in the United States each year. It is estimated, for example, that at least 125,000 Americans die each year due to a lack of medication adherence. Indeed, between 33% to 69% of all medication-related hospital admissions result from poor medication adherence, costing roughly $100 billion per year. A 2013 report on medication adherence by the National Community Pharmacists Association® reported that non-adherence adds as much as $290 billion to annual health care costs.

There exist many different methods and systems designed to increase medication adherence and avoid medication-related hospital admissions. For example, there are medications (such as pills) that are tagged and tracked in order to ensure compliance. There are also packaging designs configured to ensure compliance. There are advanced medication dispensing units that track and report an individual's compliance. Other methods and systems exist.

However, these existing methods and systems for medication adherence are intrusive, expensive, and/or ineffective. Accordingly, there is a need in the art for improved methods and systems for providing notifications to an individual about medication times and methods, and for monitoring the individual's adherence with prescribes medication routines.

### SUMMARY OF THE INVENTION

The present disclosure is directed to inventive methods and systems for providing notifications to an individual about medication times, methods, and other information, and for monitoring the individual's adherence with a prescribed medication routine. The system includes a provider side and a patient side that communicate. Once invited to the system, the patient downloads a mobile application onto a computing device. The patient can set or accept notification settings that remind the user to take, apply, or use one or more medications. The mobile applicatoin also asks for adherence information and stores and reports adherence information to the provider.

According to an aspect, a medication notification and routine adherence method includes the steps of: (i) installing a mobile application on a computing device, the mobile application in periodic communication with a medication adherence server; (ii) setting, via the mobile application, one or more medication reminders, wherein the reminder comprises information about a medication routine; (iii) receiving, by a user via the mobile application, a medication reminder; (iv) receiving, by the user via the mobile application, a request for input regarding whether the medication was taken; (v) providing input to the mobile application regarding whether the medication was taken; and (vi) receiving a medication routine adherence report, wherein the adherence report comprises information about the user's adherence with the medication routine.

According to an embodiment, the notification is a text message, an email, an alert, a pop-up, a sound, a vibration, and/or combinations thereof, among many other possibilities.

According to an embodiment, the step of setting the one or more medication reminders comprises the step of accepting a suggested medication reminder.

According to an embodiment, the reminder comprises information about how to take the medication.

According to an embodiment, the step of providing input to the mobile application regarding whether the medication was taken comprises the step of dismissing, by the user, the notification.

According to an aspect, a medication notification and routine adherence method includes the steps of: (i) sending a patient an invitation to join a medication notification and routine adherence system; (ii) entering information about one or more medication routines for the patient into the medication notification and routine adherence system, wherein the information is communicated to the patient; (iii) reviewing one or more adherence reports about the patient, wherein the adherence report comprises information about the user's adherence with the medication routine; and (iv) providing feedback to the patient about the reviewed adherence report.

According to an embodiment, the information about one or more medication routines for the patient comprises information about when and/or how to take the medication.

According to an embodiment, the invitation comprises information about a mobile application component of the medication notification and routine adherence system.

According to an embodiment, the invitation comprises information about one or more medications.

According to an aspect, a medication notification and routine adherence system includes: a server configured to send, at a provider's direction, an invitation to a patient to download a mobile application; a computing device configured to receive the invitation and download the mobile application; a computing device database configured to store information about the patient's adherence with one or more medication routines; and a provider database in communication with the server and configured to store information about the patient's adherence with one or more medication routines; wherein the mobile application is configured to: (i) receive information from the patient regarding one or more medication reminders, wherein the reminder comprises information about a medication routine; (ii) send to the patient one or more medication reminders based on the received information; (iii) send to the patient a request for input regarding whether the medication was taken; (iv) receive information from the patient about whether the medication was taken; (v) store the received information about whether the medication was taken in the computing device database; and (vi) periodically communicate the stored information to the server; and wherein the server is configured to: (i) receive the communicated information from the mobile application; (ii) provide the stored information to the provider; (iii) receive feedback from the provider; and (iv) communicate the feedback to the mobile application.

According to an embodiment, the mobile application is further configured to communicate the feedback to the patient.

According to an embodiment, the server is further configured to receive, from the provider, information about one or more medication routines for the patient.

According to an embodiment, the feedback comprises a change to the medication routine.

These and other aspects of the invention will be apparent from reference to the embodiments described hereinafter.

### BRIEF DESCRIPTION OF THE DRAWINGS

The present invention will be more fully understood and appreciated by reading the following Detailed Description in conjunction with the accompanying drawings, in which:

FIG. 1 is a flowchart of a method for providing notifications about a medication routing to an individual and recording and reporting adherence with that routine, in accordance with an embodiment.

FIG. 2 is a schematic of a system for providing notifications about a medication routing to an individual and recording and reporting adherence with that routine, in accordance with an embodiment.

FIGS. 3A and 3B are representations of a computing device displaying a medication notification to a user and requesting adherence information, in accordance with alternate embodiments.

### DETAILED DESCRIPTION

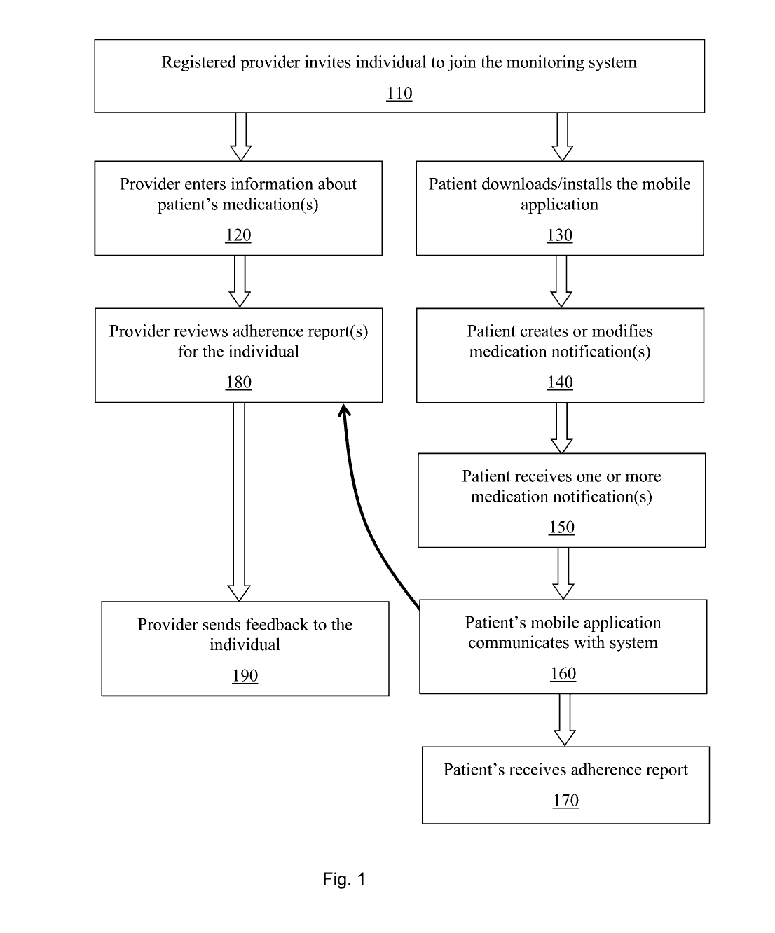

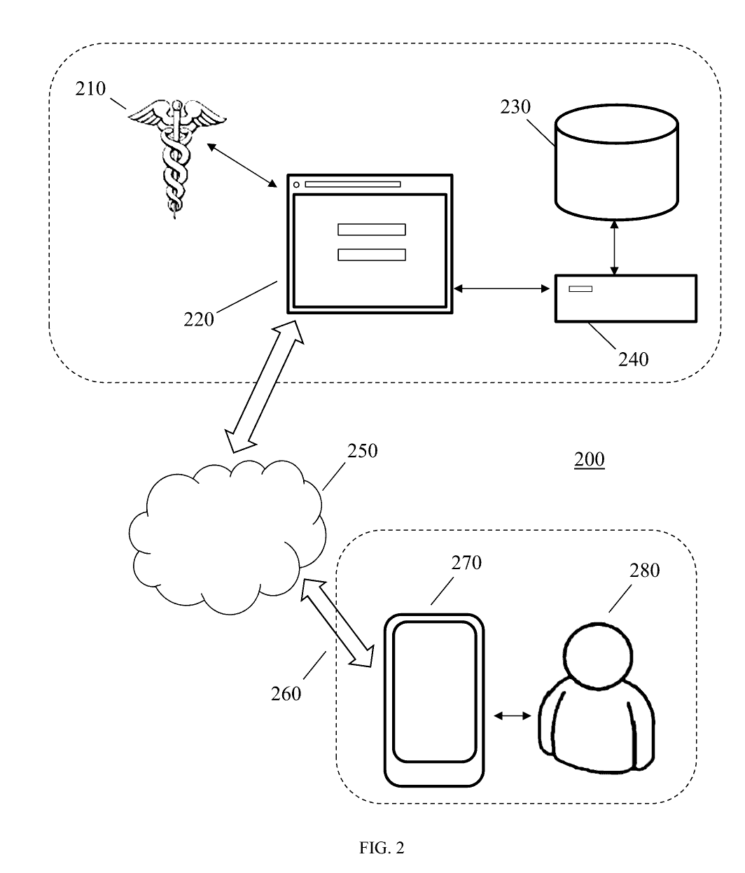

The present disclosure describes various embodiments of apparatus, systems, devices, and methods for providing notifications to an individual about medication times and methods, and for monitoring the individual's adherence with prescribes medication routines. Referring to FIG. 1, in one embodiment, is a flowchart of a method 100 for providing notifications to an individual about a medication routine, and for monitoring the individual's adherence with that routine. At step 110 of the method, a registered provider 210 (see FIG. 2) invites or allows an individual or patient to join the monitoring system. A provider can be any person that prescribes, orders, or directs a medication, physical treatment, or movement therapy routine, among many other types of medications and treatments. To be a registered provider, the provider can become a member or subscriber of the monitoring system, for example. The provider can invite or allow a patient 280 (see FIG. 2) via a website, flyer, card, text message, or a variety of other invitation mechanism. According to an embodiment, provider 210 (or an associate or assistant) accesses a website interface 220 that enables the provider to input information and sent a request or invitation to the patient 280. For example, the system 200 can send a first email to the patient containing URLs and/or information about the monitoring system, as well as a link and/or information about downloading a mobile application aspect of the monitoring system. The system 200 can also send a second email (or a second message via an alternative communications channel) to the patient containing access credentials such as a user name, password or temporary password, or other access information.

At step 120 of the method, which can occur at any point throughout the method, the provider (or an associate or assistant) inputs and/or modifies information about the individual's medication(s). This can include information about the medication's name, dosage, frequency, special instructions, dietary requirements or restrictions, and much more. The information could be entered, for example, using a preset or custom-added list or menu of items (such as times of day, for example) or newly-created instructions specific to a medication or an individual (such as “do not take medication Y at the same time as medication X”). At any time, the provider can add, edit, or remove the information about the individual's medication(s).

At step 130 of the method, which can occur before or after most other steps of the method, the patient accesses the system and downloads and/or installs a mobile application component of system 200. The patient can access the application via a mobile application platform or app store, or can access the application directly via a link from the provider, for example. Once installed, the patient can create, log in, or otherwise access an account. Access can be protected via a mechanism such as a password and/or biometric, for example. Once verified (which can involve communication with a remote server 240, for example), the account can then be populated, linked with, or otherwise connected to information about the medication(s) that the individual is taking or that the provider has indicated that the individual take or follow.

At step 140 of the method, which can occur at any point after the individual has installed the mobile application, the individual can create and/or modify one or more notifications for the medication(s) that the individual is taking or has been directed to take. For example, the individual can access the settings in order to create specific reminders for medication, including but not limited to time of notification, method of notification, and other settings. As an example, an individual with the mobile application installed has been directed to take medication XYZ three times a day with a meal. The individual accesses the settings for the application, or for the XYZ medication, and directs the system to notify her at 6:30 AM, 12:30 PM, and 6:30 PM that she needs to take medication XYZ. She directs the system to notify her via a text message to herself. Alternatively, the individual adjusts the settings to receive an alarm at 12:30 PM, or an email, a combination of these, or any other notification suitable to alert her to the need to take, apply, or use her medication(s). As yet another example, medication notifications can be provided by a medication provider or manufacturer, such as a pharmaceutical manufacturer. For example, the pharmaceutical manufacturer may set default notification or reminder settings when providing a medication.

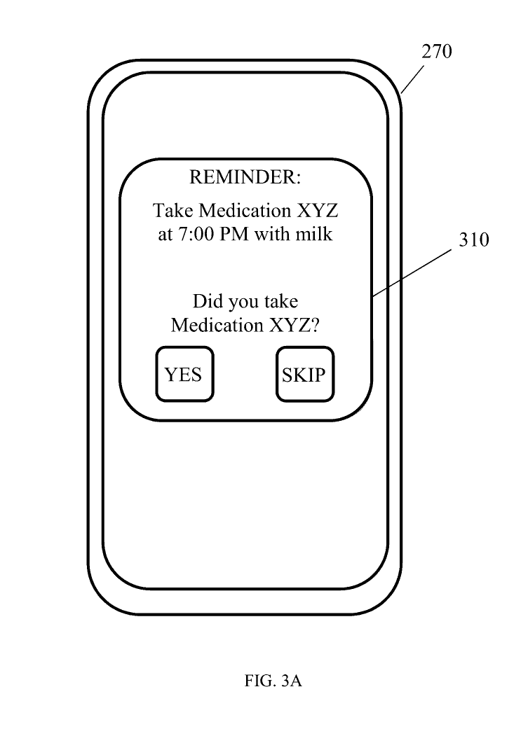

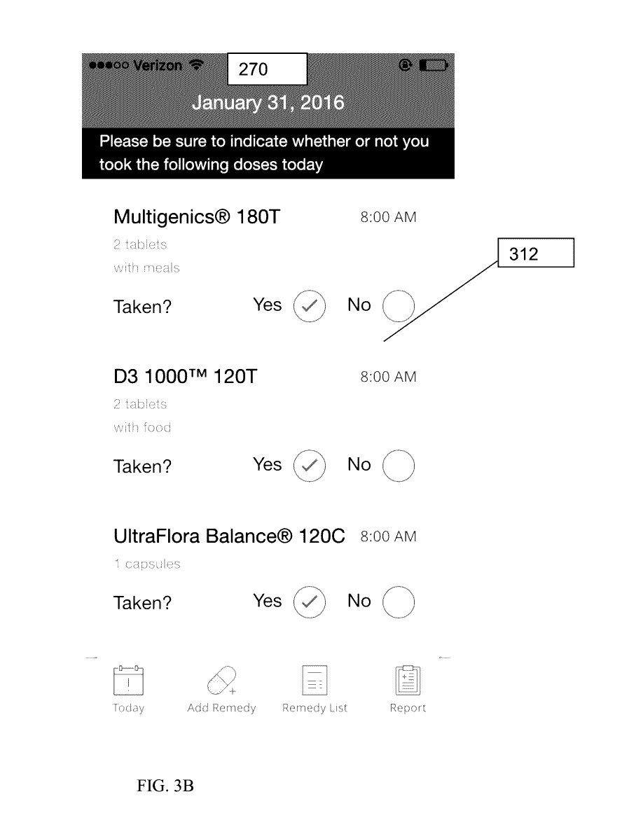

At step 150 of the method, the patient receives one or more notifications to take, apply, or use her medication(s). The notification can be one set by the provider, by the individual, or by a medication manufacturer, for example. The notification takes whichever form the provider, individual, and/or medication manufacturer set in step 140 (or in some other step). For example, the notification can be a text message, alarm, email, vibration, sound, noise, or any of a wide variety of notifications. As shown in one example in FIGS. 3A and 3B, accompanying the notification is a pop-up 310 or checklist notification 312, or other input requesting mechanism on the smartphone, tablet, PDA, laptop, desktop, watch, wearable, or other computer device 270 upon which the mobile application is installed. Pop-up 310/checklist 312 can include information about the reminder, the medication, and other information, and can also request adherence information from the individual. For example, the individual is prompted to click either “YES” (or “TAKEN” or some other indication that the individual has complied with the notification) or “SKIP” (or “NO” or “SNOOZE” or some other indication that the individual has not complied with the notification). Once the individual provides the input, or after a predetermined period of time (which may be interpreted by the system as a failure to adhere with the notification), the pop-up can close. Optionally, the system can be configured such that the pop-up will only close if an option is selected.

At step 160 of the method, which can occur before or after several other steps of the method, the individual's mobile application and/or computer device communicates with other components of the system, such as remote server 240 (which may or may not be a component of 200; for example, in some circumstances the remote server may be owned by another entity). The mobile application may receive updates to the programming, updates to the medication information, updates to patient or provider information, or a wide variety of other information. The mobile application may also send information to the system, including adherence information, notification settings and information, and/or other information about the individual. Prior to sending the information, the mobile application may compile or otherwise produce statistics or reports regarding adherence information or other information. Alternatively, the remote server may compile or produce statistics or reports regarding adherence or other information. For example, reports may include any of the following information, in addition to a wide variety of other information:
84.5% adherence
   63.5% adherence on Sundays
   100% adherence on Mondays
Notifications for Medication XYZ set for 6:30 AM, 4:00 PM, and 10:00 PM daily
Notifications for Medication ABC set for 8:00 AM and 8:00 PM daily, with a meal
   ALERT: notifications for Medication ABC deviate from prescribed settings

At step 170 of the method, which can occur before or after several other steps of the method, the individual receives an adherence report based on information collected by the system, including the remote server and/or the mobile application. The report can include any of the information described or otherwise envisioned here. For example, the report may include adherence statistics including a list or summary of missed doses, incorrect settings or notifications, or a wide variety of other information. The report may include information about the individual, the medication(s), settings, notifications and can also be accompanied by other statistics such as the provider's patient's overall adherence, the regional adherence for Medication XYZ, national adherence levels, and a wide variety of other information. As just one example, the report may include feedback or instructions from the provider which are described in more detail below with regard to step 190 of the method. The individual might be able to respond to or acknowledge the feedback or instructions.

At step 180 of the method, which can occur before or after several other steps of the method, the provider can log into or otherwise access the system 200 via a computer device, and can review any of the information described or otherwise envisioned here. For example, the provider may review any of the information provided about adherence, the individual, the medication(s), settings, notifications, or any of a wide variety of other information. The information may be formatted into reports or may be provided in a raw format. The information about the individual, the medication(s), settings, notifications can also be accompanied by other statistics such as the provider's patient's overall adherence, the regional adherence for Medication XYZ, national adherence levels, and a wide variety of other information.

At step 190 of the method, the provider can provide feedback or instructions to the individual via system 200. For example, the provider's user interface can comprise a feedback form, buttons, menu, or other input receiving mechanism. The provider's user interface can also comprise a form or other input to receive instructions. The instructions and/or feedback can then be communicated to the individual in person, by mail, or through system 200 including the mobile application. For example, the mobile application may send a pop-up, text message, or other notification to the individual that instructions or feedback has been received from the provider.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A medication notification and routine adherence method, the method comprising the steps of:
installing a mobile application on a computing device, the mobile application in periodic communication with a medication adherence server;
setting, via the mobile application, one or more medication reminders, wherein the reminder comprises information about a medication routine;
receiving, by a user via the mobile application, a medication reminder;
receiving, by the user via the mobile application, a request for input regarding whether the medication was taken;
providing input to the mobile application regarding whether the medication was taken;
receiving a medication routine adherence report, wherein the adherence report comprises information about the user's adherence with the medication routine.

2. The method of claim 1, wherein the notification is selected from the group consisting of a text message, an email, an alert, a pop-up, a sound, a vibration, and combinations thereof

3. The method of claim 1, wherein the step of setting the one or more medication reminders comprises the step of accepting a suggested medication reminder.

4. The method of claim 1, wherein the reminder comprises information about how to take the medication.

5. The method of claim 1, wherein the step of providing input to the mobile application regarding whether the medication was taken comprises the step of dismissing, by the user, the notification.

6. A medication notification and routine adherence method, the method comprising the steps of:
sending a patient an invitation to join a medication notification and routine adherence system;
entering information about one or more medication routines for the patient into the medication notification and routine adherence system, wherein the information is communicated to the patient;
reviewing one or more adherence reports about the patient, wherein the adherence report comprises information about the user's adherence with the medication routine;
providing feedback to the patient about the reviewed adherence report.

7. The method of claim 6, wherein the information about one or more medication routines for the patient comprises information about when to take the medication.

8. The method of claim 6, wherein the information about one or more medication routines for the patient comprises information about how to take the medication.

9. The method of claim 6, wherein the invitation comprises information about a mobile application component of the medication notification and routine adherence system.

10. The method of claim 6, wherein the invitation comprises information about one or more medications.

11. A medication notification and routine adherence system, the system comprising:
a server configured to send, at a provider's direction, an invitation to a patient to download a mobile application;
a computing device configured to receive the invitation and download the mobile application;
a computing device database configured to store information about the patient's adherence with one or more medication routines; and
a provider database in communication with the server and configured to store information about the patient's adherence with one or more medication routines;
wherein the mobile application is configured to: (i) receive information from the patient regarding one or more medication reminders, wherein the reminder comprises information about a medication routine; (ii) send to the patient one or more medication reminders based on the received information; (iii) send to the patient a request for input regarding whether the medication was taken; (iv) receive information from the patient about whether the medication was taken; (v) store the received information about whether the medication was taken in the computing device database; and (vi) periodically communicate the stored information to the server;
wherein the server is configured to: (i) receive the communicated information from the mobile application; (ii) provide the stored information to the provider; (iii) receive feedback from the provider; and (iv) communicate the feedback to the mobile application.

12. The system of claim 11, wherein the mobile application is configured to communicate the feedback to the patient.

13. The system of claim 11, wherein the notification is selected from the group consisting of a text message, an email, an alert, a pop-up, a sound, a vibration, and combinations thereof

14. The system of claim 11, wherein the reminder comprises information about how to take the medication.

15. The system of claim 11, wherein the information about one or more medication routines for the patient comprises information about when to take the medication.

16. The system of claim 11, wherein the invitation comprises information about one or more medications.

17. The system of claim 11, wherein the server is further configured to receive, from the provider, information about one or more medication routines for the patient.

18. The system of claim 11, wherein the feedback comprises a change to the medication routine.
